(19) United States
(12) Patent Application Publication
(10) Pub. No.: US 2006/0060164 A1
(43) Pub. Date: Mar. 23, 2006

(54) Internal combustion engine without oil

(76) Inventor: Sten Rutger Gerfast, Mendota Heights, MN (US)

Correspondence Address: STEN R. GERFAST, 1802 VALLEY CURVE ROAD, MENDOTA HEIGHTS, MN, 55118, US

(21) Appl. No.: 10/944,922

(22) Filed: Sep. 20, 2004

(51) Int. Cl. F02F 7/00; F01M 9/10; F02F 3/00

(52) U.S. Cl. 123/195 R; 123/196 R; 123/193.4

(57) ABSTRACT

This invention concerns internal combustion engines without lubricating oil. In a 2-stroke design this means that no oil is mixed into the fuel. In a 4-stroke design the engine would not have an oil pump or an oil reservoir. Both the 2 stroke and 4 stroke engines of this invention has rotating parts that are journalled with anti-friction bearings and the engines sliding parts are lubricated with low friction materials.

### BACKGROUND OF THE INVENTION

This invention concerns two-stroke and four-stroke internal combustion engines that does not require any oil to be mixed in the fuel, or oil that is pressure lubricating or splash-lubricating rotating and sliding parts. The rotating parts are journalled with anti friction bearings and sliding parts are lubricated with low friction heat resistant materials. Its construction substantially eliminates pollution from the burning of lubricating oil and minimizes oil usage. It also has low weight and simplicity that enhances its fuel efficiency and running characteristics.

### DESCRIPTION OF RELATED ART

Two-stroke internal combustion engines, have been, and are used today because they have advantages such as simplicity and economical manufacturing as well as more power per unit weight when compared to 4-stroke engines. The two-stroke engine produces one power stroke for every revolution of its crankshaft, when the 4-stroke engine produces only one power stroke for every other revolution.This translates into an engine with low weight that is very important in both the transportation industries for good fuel economy and in hand carried equipment such as chain saws and leaf blowers.Two-stroke engines, belonging to the prior art, take advantage of the fact that a negative pressure is created in the crankcase when the piston is in its top-most positions. This negative pressure draws in the fuel-air mixture into the crankcase. When the piston reaches the bottom of its stroke the pressurized mixture in the crankcase reaches the scavenging port and it flows into the combustion chamber. Normally a piston with a wedge-shaped top directs the air-fuel mixture towards the top of the cylinder, pushing the exhaust gases ahead of it towards the exhaust port. This scavenging and exhaust process has some timing overlap that results in some of the air-fuel mixture being pushed out into the exhaust creating some waste of fuel.

With the crankcase used for pressurizing the air-fuel mixture it is impossible to have the crankcase used as a lubricating oil sump that is normally used on 4-stroke engines.

The design of two-stroke engines, belonging to the present art, requires oil to be mixed into the fuel to be able to lubricate the rotating crankshaft and connecting rod and the sliding piston in the cylinder. Variation in the area of two-stroke designs such as ball bearings on the crankshaft exists in the present art, but the lubrication of the sliding piston in the cylinder has been by mixed or injected oil. This oil that is mixed with the fuel will burn and create fumes that are a pollution problem. The mixing of oil in the correct proportion, as well as the nuisance of the mixing, are additional problems, but the major deterrent for the use of 2-stroke engines has been the polluting exhaust with burned remnants of oil.

The design of the 4-stroke engine, belonging to the present art, has many additional rotating or sliding parts that are generally lubricated with oil from the crankcase-containing sump. This includes the cam shaft and its followers, rocker arms and valves in addition to the parts mentioned for the 2-stroke, like the sliding piston in its cylinder, crankshaft and connecting rod. Many variations and improvements in the area of 4-stroke designs have been implemented in the present art.

This includes overhead camshaft, rolling-type bearings on camshaft followers and pressure lubricated oil-gallery for lubricating many of its rotating and sliding parts.

In the present art 4-stroke design the piston is sliding in the cylinder while it is either pressure lubricated or splash lubricated with oil. The oil is normally pressurized with an oil pump.

Variations or improvements have been to use a multitude of piston rings including oil-scraping rings to minimize oil pollution or burning of oil. The present art 4-stroke engine does not burn any substantial oil today, and whatever oil is still coming from automobile engines is re-burned in catalytic converters. But a substantial amount of oil is used as lubricating oil that is changed at regular intervals. An engine is still desirable that would not use lubricating oil or oil-changes, would not need an oil-pump or a large catalytic converter.

### SUMMARY OF THE INVENTION

It is the object of the present invention to substantially eliminate lubricating oil in internal combustion engines by journalling anti-friction bearings between rotating and fixed components and placing low friction materials between sliding components.

The term anti-friction bearings include ball bearings or roller bearings that are either tapered or straight. They are sometimes lubricated for life with high temperature grease and have been used in both automotive and industrial applications with success.

When used in alternators, electric motors or gearboxes they are considered to be service-free for the lifetime of the automotive equipment or the equipment that they are designed into.

Their application and service life as stated in the present invention should be no less.

Another anti-friction bearings that is well regarded in both transportation equipment and industry in general is the sintered oil impregnated sleeve bearing. When the sintered bearings are used in some of the applications mentioned above, they are also considered to be lifetime bearings.

As an example some electric motors with sintered bearings have a 5-year continuous run guaranty. All of the bearings mentioned above are consider being anti-friction bearings as stated in the present invention.

When anti-friction bearings are assembled to a crankshaft, as in this invention, it would be beneficial to have the bearing split in half with a 180 degree bearing cap carrying one half of the rollers in the bearing. One of the major sliding components in a combustion engine is the piston sliding up and down in the cylinder. In the present invention the piston is lubricated by the use of a plurality of piston rings that are manufactured from graphite or a combination of graphite with polyimide, fluorocarbon or polyether compounds. Graphite could also be used in the form of fiber cloth reinforced structural graphite with the above materials.

These materials are all high temperature rated and provides for a low friction between the piston rings and the cylinder wall without resorting to the use of oil.

They also provide a good gas seal and are self lubricating for long life.

The graphite's atomic structure provides for atomic cleavage planes that in effect are flakes sliding on top of each other to achieve the self-lubrication. Graphite or carbon-graphite is available in different forms; one with a 5 micron grain size and about 13,000 PSI strength has been used successfully. If the piston is made from aluminum an anodizing coat will absorb some graphite making the piston wall more scuff-resistant. Another object of the present invention is of course to minimize the pollution in the atmosphere by mostly eliminate lubricating oil and oil changes.

The usage of hydro-carbon oil and grease, in this invention, is limited to self contained pockets or porosity in sealed anti-friction bearings or sintered bearings where they will be retained during the life-time of the equipment.

### BRIEF DESCRIPTION OF THE DRAWING

FIG. 1 is an exploded view of a 2-stroke engine showing the basic parts of the present invention.

FIG. 2 is an exploded view of a 4-stroke engine showing the basic parts of the present invention.

### DETAILED DESCRIPTION OF THE DRAWING

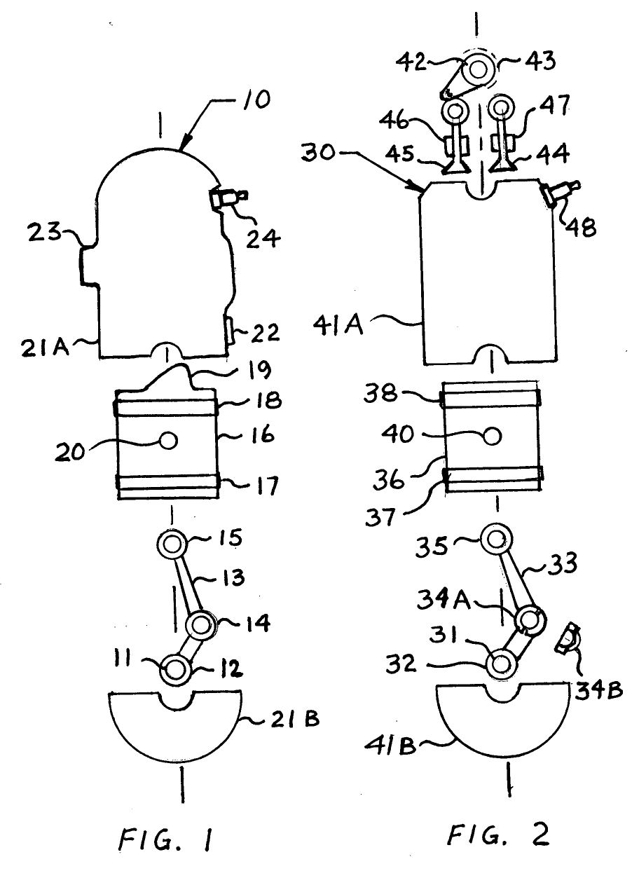

FIG. 1 illustrates one possible embodiment 10 of the present invention in its 2-stroke form with a crankshaft 11 journalled with bearing 12, a connecting rod 13 journalled with 2 bearings 14 and 15. The connecting rod 13 is transmitting force between the crankshaft 11 and a piston 16 having a plurality of piston rings shown as 17 and 18 with a wedge-shaped top 19. The piston 16 also has a point 20 for connecting rod bearing 15 to the piston.

The cylinder 21 A has an inlet for air-fuel mixture 22 towards the cylinders lower part and an exhaust port 23 further up on its opposite side. A spark plug 24 is also shown towards the cylinders upper part. A lower part of the cylinder 21 B is also shown.

This figure shows only one of the many possible configurations, with only its basic parts illustrated; a person skilled in the art could easily sketch multiple others.

FIG. 2 illustrates one possible embodiment 30 of the present invention in its 4-stroke form with a crankshaft 31 journalled with bearing 32, a connecting rod 33 journalled with a upper split bearing 34 A and a lower bearing cap 34 B as well as a top bearing 35.

The connecting rod 33 is transmitting force between the crankshaft 31 and a piston 36 having a plurality of piston rings shown as 37 and 38.

The piston 36 also has a point 40 for connecting rod bearing 35 to the piston.

The cylinder 41 A has a camshaft 42 with bearing 43 and two valves 44 and 45 that are slidably fitted with valve guides 46 and 47.

A spark plug 48 is also shown. A lower part of the cylinder 41 B is also shown.

Both of these figures shows only one of the many possible configurations, with only its basic parts illustrated;

a person skilled in the art could easily sketch multiple others.

I claim:

1. An internal combustion engine without lubricating oil comprising:
a crankshaft connected to a connecting rod, both journalled with anti-friction bearings,
said rod connected to a piston having a plurality of piston rings slidably fitted in a cylinder,
wherein said piston rings are made from low friction heat-resistant graphite material.

2. An internal combustion engine without lubricating oil comprising:
a crankshaft connected to a connecting rod, both journalled with anti-friction bearings,
a camshaft journalled with anti-friction bearings, and driven from said crankshaft
said camshaft actuating valves slidably fitted with valve guides in a cylinder,
said rod connected to a piston having a plurality of piston rings slidably fitted in said cylinder,
wherein said piston rings and said valve guides are made from low friction heat-resistant graphite material.

3. An internal combustion engine as defined in claim 1 wherein said piston is having at least one ring towards the top, and at least one ring towards the bottom of said piston, slidably fitted in said cylinder.

4. An internal combustion engine as defined in claim 2 wherein said piston is having at least one ring towards the top, and at least one ring towards the bottom of said piston, slidably fitted in said cylinder.

5. An internal combustion engine as defined in claim 1 wherein said low friction heat-resistant material is graphite with at least 13,000 P.S.I. strength.

6. An internal combustion engine as defined in claim 2 wherein said low friction heat-resistant material is graphite with at least 13,000 P.S.I. strength and with a grain size of 5 micron or less.

7. An internal combustion engine as defined in claim 1 wherein said low friction heat-resistant material is a combination of graphite and one or more of polyimide, fluorocarbon or polyether compounds.

8. An internal combustion engine as defined in claim 2 wherein said low friction heat-resistant material is a combination of graphite and one or more of polyimide, fluorocarbon or polyether compounds.

9. An internal combustion engine as defined in claim 1 wherein said low friction heat-resistant material is reinforced fiber-cloth structural graphite.

10. An internal combustion engine as defined in claim 2 wherein said low friction heat-resistant material is reinforced fiber-cloth structural graphite.

11. An internal combustion engine as defined in claim 1 wherein said plurality of piston rings are sprung towards said cylinder, producing a minimal gap in said rings by the manufacturing tolerances of said rings, to produce a good gas seal.

12. An internal combustion engine as defined in claim 2 wherein said plurality of piston rings are sprung towards said cylinder, producing a minimal gap in said rings by the manufacturing tolerances of said rings, to produce a good gas seal.

13. An internal combustion engine as defined in claim 11 wherein said gaps angular position is controlled in assembly of rings, piston and cylinder.

14. An internal combustion engine as defined in claim 12 wherein said gaps angular position is controlled in assembly of rings, piston and cylinder.

15. An internal combustion engine as defined in claim 11 wherein said spring loading is aided by a spring member under said rings, producing a good gas seal.

16. An internal combustion engine as defined in claim 12 wherein said spring loading is aided by a spring member under said rings, producing a good gas seal.

17. An internal combustion engine as defined in claim 11 wherein said piston rings are sectioned and consists of at least two cylindrical sectors.

18. An internal combustion engine as defined in claim 12 wherein said piston rings are sectioned and consists of at least two cylindrical sectors.

19. An internal combustion engine as defined in claim 1 wherein said piston is having a flat top without a wedge shape.

20. An internal combustion engine as defined in claim 1 wherein said piston and said cylinder are having an anti-friction coating selected from the group of anodizing, plating, hard coat anodizing and sealed hard coat anodizing.

21. An internal combustion engine as defined in claim 2 wherein said piston and said cylinder are having an anti-friction coating selected from the group of anodizing, plating, hard coat anodizing and sealed hard coat anodizing.

22. An internal combustion engine as defined in claim 1 wherein said anti-friction bearings are high temperature grease filled ball bearings or roller bearings with straight or tapered rollers.

23. An internal combustion engine as defined in claim 2 wherein said anti-friction bearings are high temperature grease filled ball bearings or roller bearings with straight or tapered rollers.

24. An internal combustion engine as defined in claim 1 wherein said anti-friction roller bearings are split in half with a 180 degree bearing cap carrying one half of the rollers in the bearing.

25. An internal combustion engine as defined in claim 2 wherein said anti-friction roller bearings are split in half with a 180 degree bearing cap carrying one half of the rollers in the bearing.

26. An internal combustion engine as defined in claim 1 wherein said piston rings inside free diameter is equal to said pistons diameter, and said rings are compressed in assembly.

27. An internal combustion engine as defined in claim 2 wherein said piston rings inside free diameter is equal to said pistons diameter, and said rings are compressed in assembly.

28. An internal combustion engine without lubricating oil comprising:
a crankshaft connected to a connecting rod, both journalled with anti-friction bearings,
said rod connected to a piston having a plurality of piston rings, at least one towards the top, and at least one towards the bottom of said piston, slidably fitted in a cylinder
wherein said piston rings are made from materials selected from a group of low friction heat-resistant materials including graphite with at least 13,000 P.S.I. strength, polyimide, flourocarbon or polyether compounds.

29. An internal combustion engine as defined in claim 28 wherein said low friction heat-resistant materials allowing said engine to be operated at high temperatures.

30. An internal combustion engine as defined in claim 11 wherein said rings diameter are exceeding said pistons diameter by a minimum of one half millimeter.

31. An internal combustion engine as defined in claim 12 wherein said rings diameter are exceeding said pistons diameter by a minimum of one half millimeter.

32. An internal combustion engine as defined in claim 28 wherein said anti-friction bearings oil or grease fills are contained in sealed pockets.

33. An internal combustion engine as defined in claim 2 wherein said camshaft is driven from said crankshaft using a timing chain or a timing belt.
